(19) United States
(12) Patent Application Publication
(10) Pub. No.: US 2009/0258140 A1
(43) Pub. Date: Oct. 15, 2009

(54) Method for coating the outer surface of a cylinder sleeve

(76) Inventor: Gerhard Bucher, Ludwigsburg (DE)

Correspondence Address: COLLARD & ROE, P.C., 1077 NORTHERN BOULEVARD, ROSLYN, NY, 11576, US

(21) Appl. No.: 11/991,235

(22) PCT Filed: Aug. 31, 2006
(86) PCT No.: PCT/DE2006/001529

§ 371 Date: Feb. 29, 2008

(30) Foreign Application Priority Data
Sep. 1, 2005 (DE) 102005041410.9

(51) Int. Cl. B05D 3/12

(52) U.S. Cl. 427/242

(57) ABSTRACT

The invention relates to a method for coating the outer surface of a cylinder bushing. A small segment of the cylinder bushing is immersed into a melt which consists of a zinc based alloy comprising alloy components of aluminium and copper and which extends in a continuous manner over the entire axial length of the cylinder bushing, after cleaning and roughening the external surface, and the cylinder bushing is rotated about the longitudinal axis thereof, until a metal layer is formed on the outer surface of the cylinder bushing, which extends in a continuous manner over the entire length thereof and which consists of a zinc based alloy. The copper prevents an oxide skin, which is difficult to remove from the metal layer, from forming and also increases rigidity in the binding layer.

The invention relates to a method for coating the outer surface of a cylinder sleeve, according to the preamble of claim 1.

In order to reduce the weight of motor vehicles, and to save fuel in this way, cylinder crankcases are cast from light metal, particularly aluminum. However, these have such poor tribological properties that in their production, cylinder sleeves made of an iron-based material, for example gray cast iron, are cast into the cylinder crankcase, as well. In this connection, problems occur with anchoring the cylinder sleeves in the cylinder crankcase in sufficiently firm manner, and with guaranteeing a sufficient heat transfer between the cylinder sleeves and the cylinder crankcase. These problems can be solved in that the outer surfaces of the cylinder sleeves are given a rough-cast structure with undercuts. However, this brings with it the result that the crosspieces between the cylinder sleeves cast into the cylinder crankcase are very broad, and that therefore the space requirement of the cylinder sleeves is very great.

Within the scope of the trend in engine development, of reducing the size of the engines while maintaining performance, there is the need to reduce the distances between the individual cylinder sleeves, and, at the same time, to improve the heat removal from the combustion chamber to the cooling chambers of the cylinder crankcase, by way of the cylinder sleeve. These problems can be solved in that, as an alternative to a rough-cast sleeve, cylinder sleeves made of gray cast iron having a smooth or moderately rough outer surface and having a coating are used, which coating assures bonding of the cylinder sleeve to the surrounding cast material of the cylinder crankcase.

It is known from the U.S. Pat. No. 5,333,668 to use a zinc-based alloy containing 5% aluminum for this purpose. It is a disadvantage, in this connection, that the coating known from the prior art oxidizes very quickly, and has only moderate strength values, which impairs the quality of the metallic bond of the coating to the surrounding cast material of the cylinder crankcase.

It is the task of the invention to avoid this disadvantage of the state of the art, and furthermore to make a simple and price-advantageous coating method available.

This task is accomplished with the characteristics standing in the characterizing part of the main claim. Practical embodiments of the invention are the object of the dependent claims.

The method according to the invention, for coating a cylinder sleeve to be cast into a cylinder crankcase, will be explained in greater detail below.

A cylinder sleeve that consists of an iron-based material, which can be alloyed or unalloyed, is used for this purpose. Preferably, the cylinder sleeve consists of gray cast iron, which can contain either lamellar graphite, vermicular graphite, or spherical graphite. In this connection, the gray cast iron can have a ferrite/perlite, perlite, bainite, or austenite basic structure. The outer surface of the cylinder sleeve can be configured to be smooth. However, it can also have any other surface quality, all the way to a flat rough-cast surface. Furthermore, the outer surface, the face, and the inner surface of the cylinder sleeve can be pre-processed by means of lathing.

Any conventional casting methods, such as the die-casting method, the pressure casting method, the gravity casting method, or the low-pressure casting method, can be used for casting the cylinder sleeve into the cylinder crankcase.

The cylinder crankcase consists of one of the usual light metal casting material, whereby casting materials both on an aluminum basis, such as EN AC—AlSi10Mg(Fe), EN AC—AlSi10Mg(Cu), EN AC—AlSi9Cu3(Fe), EN AC—AlSi12(Cu), for example, and on a magnesium basis, such as EN-MC—MgAl9Zn1(A), EN MC—MgY4RE3Zr, for example, can be used.

In order to assure the metallic bond of the cylinder sleeve to the surrounding casting material of the cylinder crankcase when the cylinder sleeve is cast into the cylinder crankcase, the outer surface of the cylinder sleeve is coated using the dipping method. As preparation for this, it is necessary to clean the outer surface of dirt and oxides, and subsequently to roughen it up. Suitable methods for this are brushing and/or sandblasting. Coarse corundum, i.e. crystallized Al₂O₃, for example, can be used for sandblasting.

Subsequent to this, the outer surface of the cylinder sleeve is then etched and/or coated with a flux, for which purpose zinc chloride/aluminum chloride double salt or ammonium chloride are suitable. This brings about the result of removing oxides from the outer surface of the cylinder sleeve, in order to promote alloying of a metal layer, which will be described below, onto the surface.

The subsequent dipping method for coating the outer surface of the cylinder sleeve takes place in a zinc-aluminum-copper melt containing 3% to 12% copper and 2% to 8% aluminum, whereby the remainder of the melt is zinc. To promote precipitation hardening, up to 1% magnesium can be added to the melt.

In this connection, the cylinder sleeve is dipped so far into the melt until a small segment of the outer surface that is continuous over the entire axial length of the cylinder sleeve, but not the inner surface of the cylinder sleeve, is wetted by the melt. The cylinder sleeve is then rotated about its longitudinal axis, whereby the melt is put into high-frequency motion by means of ultrasound. As a result, the alloy formation between the alloy of the cylinder sleeve and the zinc-based alloy of the melt is promoted, whereby a layer system of intermetallic phases and mixed crystals is formed, which assures the metallic bond of the cylinder sleeve to the surrounding metal layer.

After three to five minutes, the metal layer has reached a thickness of 100 μm to 300 μm, and the cylinder sleeve is removed from the melt. The cylinder sleeve is then attached horizontally in a holder, whereby excess melt drips off, and the metal layer that has been applied solidifies.

The copper component of the alloy has the advantage that an oxide skin that might form during coating does not become too dense, so that it easily comes loose during casting in. The liquid temperature of the melt lies between 440° C. and 520° C., thereby bringing about the result that the metal layer starts to be melted by the surrounding material during casting of the cylinder crankcase, thereby assuring the metallic bond between the cylinder sleeve and the surrounding cast material of the cylinder crankcase. If the gravity casting method is used for this purpose, it is necessary to heat the coated cylinder sleeves to 300° C. to 400° C. This is eliminated when using the die-casting method to produce the cylinder crankcase.

1. Method for coating the outer surface of a cylinder sleeve,
wherein the following method steps,
the outer surface is cleaned,
the outer surface is roughened up by means of brushing and/or sandblasting,
the outer surface is coated with a flux,
a small segment of the outer surface, which is continuous over the entire axial length of the cylinder sleeve, is dipped into a melt of a zinc-based alloy having alloy components of aluminum and copper,
the cylinder sleeve is rotated about its longitudinal axis until a continuous metal layer consisting of the zinc-based alloy has formed on the outer surface of the cylinder sleeve, over the entire axial length of the cylinder sleeve,
the cylinder sleeve is removed from the melt.

2. Method according to claim 1, wherein the outer surface is sandblasted with corundum.

3. Method according to claim 1, wherein the outer surface of the cylinder sleeve is coated with zinc chloride/aluminum chloride double salt as a flux.

4. Method according to claim 1, wherein the outer surface of the cylinder sleeve is coated with aluminum chloride as a flux.

5. Method according to claim 1, wherein 3% to 12% copper and 2% to 8% aluminum are added to the zinc-based alloy.

6. Method according to claim 1, wherein up to 1% magnesium is added to the zinc-based alloy.

7. Method according to claim 1, wherein the cylinder sleeve is rotated about its longitudinal axis for three to five minutes.

8. Method according to claim 1, wherein a metal layer having a thickness of 100 μm to 300 μm is formed.
